(19) United States
(12) Patent Application Publication
(10) Pub. No.: US 2008/0101695 A1
(43) Pub. Date: May 1, 2008

(54) Color reproduction correction circuit and correction method

(75) Inventor: Tomoaki Uchida, Noda (JP)

Correspondence Address: Nields & Lemack, 176 E. Main Street, Suite #5, Westboro, MA, 01581, US

(73) Assignee: Info Vision Optoelectronics Holdings Limited

(21) Appl. No.: 11/977,328

(22) Filed: Oct. 24, 2007

(30) Foreign Application Priority Data
Oct. 25, 2006 (JP) JP-2006-289402

(51) Int. Cl. G06K 9/00

(52) U.S. Cl. 382/167

(57) ABSTRACT

The invention discloses a color reproduction correction circuit and correction method, it comprises: a reverse gamma correction section for receiving at the reception side the video signal, which has been gamma corrected at the transmission side, and the video signal is corrected by the reverse gamma correction to become linear data; a correction matrix transformation section for transforming the linear data, which has been performed a reverse gamma correction, through a correction matrix, which is formed by the product of the first transformation matrix and the second transformation matrix, wherein said first transformation matrix transforms the video signal of RGB system to the video signal of XYZ system at the transmission side, and said second transformation matrix transforms the video signal of XYZ system to the video signal of RGB system at the reception side. By using the color reproduction correction circuit of the invention, even though the color reproduction region of the device at the transmission side is different from that of the device at the reception side, the color reproduction can still be performed more accurately, and when the color reproduction region of the display device at the reception side is wider than that of the display device at the transmission side, the color reproduction can be performed by extending automatically the color reproduction region.

### TECHNICAL FIELD

The invention relates to a color reproduction correction circuit and a color reproduction correction method used for reproducing correctly the color for color displaying of a color display device.

### BACKGROUND ART

Recently, in the display device for the video signals, the color reproduction region is increased continually. However, the color reproduction region of the camera device at the transmission side for transmitting images, such as the television image and the image of the packed medium, and the like, still remains its original size, and there are many conditions in which the size of the color reproduction region of the camera device at the transmission side for transmitting the images and the size of the color reproduction region of the display device for reproducing the color, such as the display device for displaying the video signals at the reception side, are different. If the color reproduction region of the camera device at the transmission side is different from the color reproduction region of the display device at the reception side, such as the display device for displaying the video signals, then the color reproduction cannot be implemented correctly by using the display device. The content disclosed in a Japanese Patent Application-Publication No. 9-139855 is incorporated herein for reference in its entirety.

A schematic block diagram of a typical system in the prior art for the video signals from the transmission side to the reception side is shown in FIG. 2. In FIG. 2, 101 is a camera device, 102 is a gamma correction section, 103 is a transfer matrix transformation section, 104 is a reverse matrix transformation section, 106 is a display device, 121 is RGB signal (Hereinafter also referred to as the R1G1B1 signal) which is taken by the camera device 101, 122 is a signal (Hereinafter also referred to as R1_{γ} G1_{γ} B1_{γ} signal) produced after gamma correcting R1G1B1 signal 121, 123 is a signal which is positioned to follow a brightness signal (Hereinafter referred to as Y) and two color-difference signals (Hereinafter referred to as U, V) transformed from a R1_{γ}G1_{γ}B1_{γ} signal 122 by the transfer matrix transformation section 103, 124 is a signal which is reproduced by the reverse matrix transformation section 104 at the reception side, and 126 is an output signal of the display device 106. Furthermore, “1” in the above R1G1B1 signal is referred to as a signal which is at the transmission side.

As shown in FIG. 2, the video signal, which is taken by the camera device, is gamma corrected by the gamma correction section 102, and it is then transformed by the transfer matrix transformation section 103 to a form, which can be transferred easily, for transferring. The video signal transferred is firstly reproduced in the reverse matrix transformation section 104 at the reception side, and then it is transferred to the display device 106, and the signal 124 is used for displaying the image by the display device 106.

If the color reproduction region of the camera device at the transmission side transmitting the image is different from that of the display device at the reception side for displaying the video signal in the said flow procedure of video signal, then the color reproduction cannot be implemented correctly by using the display device.

The examples of the chroma graphs for the 3 primary colors held by the device at the transmission side and the 3 primary colors held by the device at the reception side are shown in FIG. 3. In FIG. 3, 301 is the chroma diagram of the 3 primary colors at the transmission side, and 302 is the chroma diagram of the 3 primary colors at the reception side.

Referring to FIG. 3, the color reproduction region of the device at the transmission side is compared with the color reproduction region of the device at the reception side, generally, the color reproduction region of the device at the reception side is wider, and there is difference between two color reproduction regions. If the color reproduction regions are different, then the display device 106 cannot reproduce the color correctly.

However, no any right resolution methods directing on said problem can be found in the prior art, only the significant color, such as the memorized color, can be corrected partly.

### SUMMARY OF THE INVENTION

Thus, the object of the invention is to provide color correction circuits within the devices at the transmission side and the reception side, even though the color reproduction regions associated with the 3 primary colors are different, the color reproduction can also be performed accurately, when the color reproduction region of the display device at the reception side is wider than that of the device at the transmission side, the color reproduction region can be extended automatically, and the color can be reproduced.

According to an aspect of the invention, a color reproduction correction circuit is provided, the color video signal transmitted from the transmission side, which transmits the video signal, is received by said color reproduction correction circuit at the reception side and is corrected, than it is color displayed by a color display device. Said color reproduction correction circuit comprises:

a reverse gamma correction section for receiving at the reception side the video signal, which has been gamma corrected at the transmission side, and the video signal is corrected by the reverse gamma correction to become linear data;

a correction matrix transformation section for transforming the linear data, which has been performed a reverse gamma correction, through a correction matrix.

Further, the correction matrix is the product of the first transformation matrix and the second transformation matrix, wherein said first transformation matrix transforms the three primary colors and the white color at the transmission side from the video signal of RGB system to the video signal of XYZ system and said second transformation matrix transforms the three primary colors and the white color at the reception side from the video signal of XYZ system to the video signal of RGB system.

According to another aspect of the invention, a color display device having a color reproduction correction circuit described above is provided. More specifically, the color video signal transmitted by the transmission side, which transmits the video signal, is received by the color reproduction correction circuit at the reception side and is corrected, and it is then color displayed by a color display device.

According to yet another aspect of the invention, a color reproduction correction method is provided. The color video signal transmitted by the transmission side, which transmits the video signal, is received and by the color reproduction correction circuit at the reception side and is corrected, and it is then color displayed by a color display device, said color reproduction correction method comprises:

a process for receiving at the reception side the video signal which has been gamma corrected at the transmission side, and for correcting by the reverse gamma correction to become linear data; and

a process for performing a color correction for the linear data by a correction matrix.

Further, the product of the first transformation matrix and the second transformation matrix is used as the correction matrix, wherein said first transformation matrix transforms the three primary colors and the white color at the transmission side from the video signal of RGB system to the video signal of XYZ system and said second transformation matrix transforms the three primary colors and the white color at the reception side from the video signal of XYZ system to the video signal of RGB system.

By using the color reproduction correction circuit in the invention, even though the color reproduction region of the device at the transmission side is different from that of the device at the reception side, the color reproduction can still be performed more correctly, and when the color reproduction region of the display device at the reception side is wider than that of the device at the transmission side, the color reproduction can be performed by extending automatically the color reproduction region.

### DESCRIPTION OF FIGURES

After reading the specific embodiments in the invention together with the figures, the readers will understand more clearly the respective aspects of the invention, wherein:

FIG. 1 shows a schematic block diagram of a color reproduction correction circuit and an image processing system for transmitting and receiving the video signal and displaying the images according to one or more aspects of the invention;

FIG. 2 shows a schematic block diagram of a typical system for the video signal from transmission side to reception side in the prior art;

FIG. 3 shows the examples of the chroma graphs for the 3 primary colors held by the device at the transmission side and the 3 primary colors held by the device at the reception side; and

FIG. 4 shows a schematic block diagram of the internal structure of the color reproduction correction circuit 105 shown in FIG. 1.

Wherein the meanings of the reference signs appearing in the figures of the description are listed as follows:

101 camera device

102 gamma correction section

103 transfer matrix transformation section

104 reverse matrix transformation section

105 correction circuit

106 display device

121 RGB signal taken by camera device 101

122 a signal produced after gamma correcting R1G1B1 signal 121

123 a signal which is positioned to follow a brightness signal (Y) and two color-difference signals (Hereinafter referred to as U, V) transformed from a R1_{γ}G1_{γ}B1_{γ} signal 122 by the transfer matrix transformation section 103

124 a signal which is reproduced by the reverse matrix transformation section 104 at the reception side

125 a signal produced after correcting the reproduced signal 124

126 an output signal of the display device 106

### Preferred Embodiments of the Invention

The embodiments of the invention will be described by referring to the figures as follows.

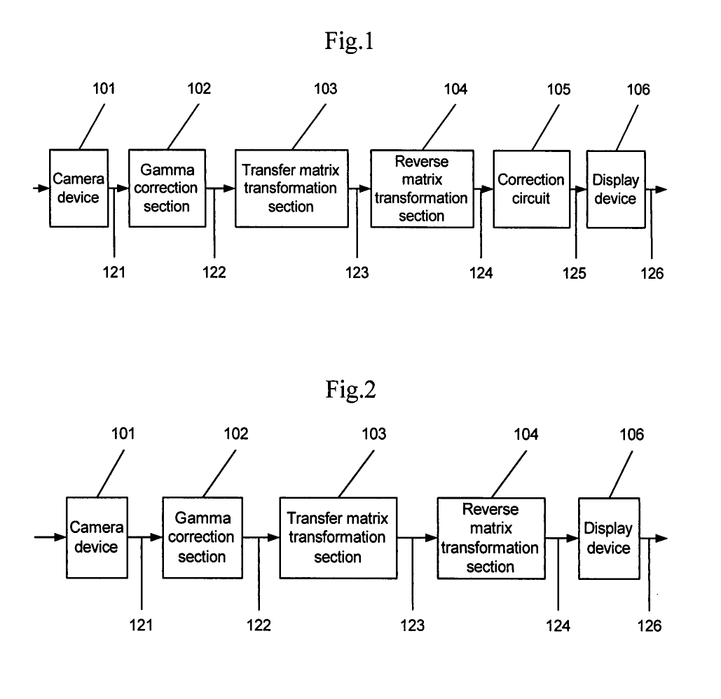

FIG. 1 shows a schematic block diagram of a color reproduction correction circuit and an image processing system for transmitting and receiving the video signal and displaying the images according to one or more aspects of the invention.

As shown in FIG. 1, 101 is a camera device, 102 is a gamma correction section, 103 is a transfer matrix transformation section, 104 is a reverse matrix transformation section, 105 is a correction circuit relating to the invention, 106 is a display device, 121 is a R1G1B1 signal which is taken by the camera device 101, 122 is a R1_{γ}G1_{γ}B1_{γ} signal which is a gamma corrected R1G1B1 signal 121, 123 is a signal which is positioned to follow a brightness signal (Hereinafter referred to as Y) and two color-difference signals (Hereinafter referred to as U, V) transformed from a R1_{γ}G1_{γ}B1_{γ} signal 122 by the transfer matrix transformation section 103, 124 is a signal which is reproduced by the reverse matrix transformation section 104 at the reception side, 125 is a signal which is corrected from a reproduced signal 124, and 126 is an output signal of the display device 106.

The correction circuit 105 shown in FIG. 1 is an exemplary correction circuit of the invention. If the correction circuit 105 in the system shown in FIG. 1 is removed, then it is the same as the image processing system in the prior art. That is, in the existing image processing system, the signal 124, which is subjected to a reproduction process at the reverse matrix transformation section 104, is supplied to the display device 106 in its original form, then it is outputted by the display device. While the correction circuit of the invention is used for further correcting the reproduced signal 124 at the reverse matrix transformation section 104, and is then supplied to the display device. The correction circuit 105 will be described in detail as follows.

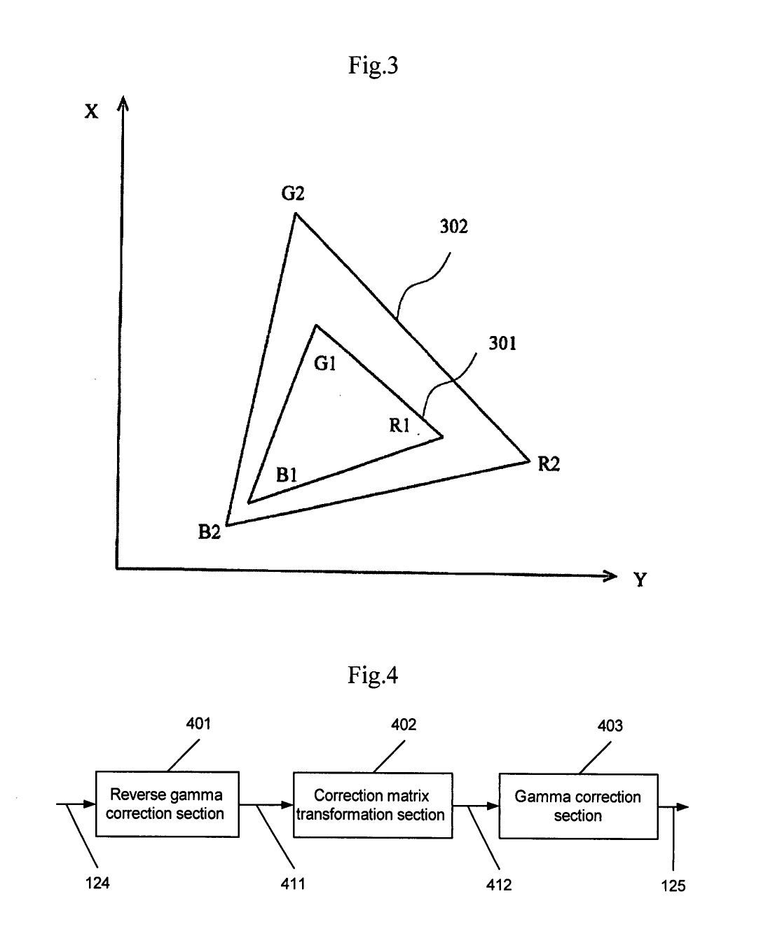

FIG. 3 shows the examples of the chroma graphs for the 3 primary colors held by the device at the transmission side and the 3 primary colors held by the device at the reception side. Referring to FIG. 3, 301 is the chroma graph for the 3 primary colors at the transmission side and 302 is the chroma graph for the 3 primary colors at the reception side.

As shown in FIG. 3, generally, the color reproduction region at the transmission side and the color reproduction region at the reception side are different. Under a condition as shown in FIG. 3, the color reproduction region 302 at the reception side is wider than the color reproduction region 301 at the transmission side.

In the embodiment, as a method of the transmission side, it will be described based on the international specification ITU-R BT.709. The 3 primary colors are R1(0.640,0330), G1(0.300,0.600), B1(0.150,0.060). The reference white color is D65 (0.3127, 0.329). Furthermore, the numbers in the parentheses indicate the chroma of x, y, respectively. The transformation shown in the following formula (1) can be performed from the chroma of the 3 primary colors and the white color to the color systems of XYZ system and RGB system:

$$\vert \begin{matrix}X \\ Y \\ Z\end{matrix} \vert = \vert \begin{matrix}0.412391 & 0.357584 & 0.180481 \\ 0.212639 & 0.715168 & 0.072192 \\ 0.019331 & 0.119195 & 0.950532\end{matrix} \vert \vert \begin{matrix}R 1 \\ G 1 \\ B 1\end{matrix} \vert = {M}_{1}^{- 1} \vert \begin{matrix}R 1 \\ G 1 \\ B 1\end{matrix} \vert \qquad ( 1 )$$

Next, for the display device at the reception side, it will be described according to R2(0.670, 0340), G2 (0.250, 0.700), B2 (0.140, 0.050) as an example. The transformation between the color systems of XYZ system and RGB system is shown as formula (2):

$$\vert \begin{matrix}R 2 \\ G 2 \\ B 2\end{matrix} \vert = \vert \begin{matrix}2.276963 & - 0.788567 & - 0.344872 \\ - 0.928253 & 1.830600 & 0.047439 \\ 0.059258 & - 0.088887 & 0.948127\end{matrix} \vert \vert \begin{matrix}X \\ Y \\ Z\end{matrix} \vert = {M}_{2} \vert \begin{matrix}X \\ Y \\ Z\end{matrix} \vert \qquad ( 2 )$$

Furthermore, regardless whether it is at the transmission side or at the reception side, all of the values of R, G, B, and Y are within the numerical range of 0˜1, and the values of U, V are within the numerical range of −0.5˜0.5.

It is known from formula (1) and formula (2) that R2G2B2 can be represented by R1G1B1 based on formula (3):

$$\begin{matrix}\vert \begin{matrix}R 2 \\ G 2 \\ B 2\end{matrix} \vert = {M}_{2} {M}_{1}^{- 1} \vert \begin{matrix}R 1 \\ G 1 \\ B 1\end{matrix} \vert \\ = \vert \begin{matrix}0.76465223 & 0.20914064 & 0.02620846 \\ 0.00737081 & 0.98291261 & 0.00971493 \\ 0.02386487 & 0.07063257 & 0.90550307\end{matrix} \vert \vert \begin{matrix}R 1 \\ G 1 \\ B 1\end{matrix} \vert\end{matrix} \qquad ( 3 )$$

It is known from formula (3), if the 3 primary colors of R1G1B1 at the transmission side are within the color reproduction region at the reception side, then the same color can be obtained.

Furthermore, the correction matrix of the correction circuit relating to the invention can be expressed by formula (4):

Correction matrix=M₂M₁⁻¹ (4)

However, the problem still exists even under such a situation. The input signal 124 and the output signal 125 of the correction circuit 105 shown in FIG. 1 are the signals, which have been gamma corrected by the gamma correction section 102. While on the other hand, formula (3) is a transformation formula relating to the linear data, in order to perform the gamma correction correctly by using formula (3), it is required that the input signal 124 is linear data. Thus, the correction circuit 105 is a circuit comprising reverse gamma correction, and the signal is linearized before correcting based on the correction matrix.

FIG. 4 shows a schematic block diagram of the internal structure of the color reproduction correction circuit 105 shown in FIG. 1. Referring to FIG. 4, the correction circuit 105 comprises mainly: a reverse gamma correction section 401, a correction matrix transformation section 402, a gamma correction section 403, a signal 124 which is reproduced by the reverse matrix transformation section at the reception side, a signal 411, which is reverse gamma corrected by the reverse gamma correction section 401, a signal 412, which is transformed by the correction matrix transformation section 402 from the reverse gamma corrected signal 411, and a signal 125, which is gamma corrected by the gamma correction section 403 from the signal 412 transformed by the correction matrix transformation section 402. Wherein, the reverse gamma corrected signal 411 is transformed to the signal 412 by the correction matrix transformation section 402 based on the correction matrix M₂M₁⁻¹.

The gamma correction performed by the gamma correction section 403 is the same as the gamma correction performed by the gamma correction section 102 at the transmission side, and can be compatible with the correction performed in the display device 106.

It is understood that when one or more aspects of the invention is described in connection with the figures, the gamma correction, the reverse gamma correction and the matrix calculation or transformation therein are the public knowledge to those skilled in the art, thus, the description thereof will be omitted herein.

In the above, the specific embodiments of the invention have been described by referring to the figures. However, it is understood by those skilled in the art that various changes and substitutions of the specific embodiments of the invention can be made without deviating from the sprit and the scope of the invention. Those changes and substitutions fall within the scope as defined in the Claims of the invention.

What is claimed is:

1. A color reproduction correction circuit, wherein it receives at the reception side the color video signal transmitted at the transmission side, which transmits the video signal, and corrects the signal, then the color display is performed through the color display device, wherein said color reproduction correction circuit comprises:
a reverse gamma correction section for receiving at the reception side the video signal, which has been gamma corrected at the transmission side, and the video signal is corrected by the reverse gamma correction to become linear data;
a correction matrix transformation section for transforming the linear data, which has been performed a reverse gamma correction, through a correction matrix.

2. The color reproduction correction circuit as claimed in claim 1, characterized in that the correction matrix is the product of the first transformation matrix and the second transformation matrix, wherein said first transformation matrix transforms the three primary colors and the white color at the transmission side from the video signal of RGB system to the video signal of XYZ system and said second transformation matrix transforms the three primary colors and the white color at the reception side from the video signal of XYZ system to the video signal of RGB system.

3. A color display device has the color reproduction correction as claimed in claim 1.

4. A color reproduction correction method, wherein it receives at the reception side the color video signal transmitted at the transmission side, which transmits the video signal, and corrects the signal, then the color display is performed through the color display device, wherein said color reproduction correction method comprises:
a process for receiving at the reception side the video signal which has been gamma corrected at the transmission side, and for correcting by the reverse gamma correction to become linear data; and
a process for performing a color correction for the linear data by a correction matrix.

5. The color reproduction correction method as claimed in claim 4, characterized in that the product of the first transformation matrix and the second transformation matrix is used as the correction matrix, wherein said first transformation matrix transforms the three primary colors and the white color at the transmission side from the video signal of RGB system to the video signal of XYZ system and said second transformation matrix transforms the three primary colors and the white color at the reception side from the video signal of XYZ system to the video signal of RGB system.
